(19) United States
(12) Patent Application Publication
(10) Pub. No.: US 2026/0302532 A1
(43) Pub. Date: Oct. 1, 2026

(54) OXIDIZED BACTERIAL CELLULOSE SEPARATOR FOR BATTERIES AND METHOD FOR PRODUCING THE SAME

(71) Applicants: Zhaoyang FAN, Chandler, AZ (US); Wenyue Li, Chandler, AZ (US); Shu Wang, Chandler, AZ (US)

(72) Inventors: Zhaoyang FAN, Chandler, AZ (US); Wenyue Li, Chandler, AZ (US); Shu Wang, Chandler, AZ (US)

(73) Assignee: ARIZONA BOARD OF REGENTS ON BEHALF OF ARIZONA STATE UNIVERSITY, Scottsdale, AZ (US)

(21) Appl. No.: 19/698,729

(22) Filed: Jun. 4, 2026

Related U.S. Application Data
(63) Continuation of application No. 18/154,037, filed on Jan. 12, 2023.
(60) Provisional application No. 63/299,164, filed on Jan. 13, 2022.

(51) Int. Cl. H01M 50/429; H01M 10/052; H01M 50/403; H01M 50/431; H01M 50/434; H01M 50/446

(52) U.S. Cl. CPC H01M 50/4295; H01M 50/403; H01M 50/431; H01M 50/434; H01M 50/446; H01M 10/052

(57) ABSTRACT

A separator for a lithium-based battery, and method for fabricating the same is disclosed. The method includes oxidizing cellulose fibrils to form oxidized cellulose having carboxylic functional groups, decorating the oxidized cellulose with nanoparticles, and forming the nanoparticle-decorated oxidized cellulose into a film to become the separator for the lithium-based battery. The cellulose may be a bacterial cellulose. The cellulose fibrils may be oxidized through a TEMPO oxidation. Decorating the oxidized cellulose with nanoparticles may include introducing a precursor solution to the oxidized cellulose that reacts with hydroxyl groups of the oxidized cellulose while preserving the carboxylic functional groups, causing the nanoparticles to nucleate on the surface of the oxidized cellulose. The nanoparticles may be composed of an oxide material. The oxide material may be SiO₂. The precursor solution may be tetraethyl orthosilicate (TEOS).

### RELATED APPLICATIONS

This application is a continuation of U.S. patent application Ser. No. 18/154,037, filed Jan. 13, 2023, titled “OXIDIZED BACTERIAL CELLULOSE SEPARATOR FOR BATTERIES AND METHOD FOR PRODUCING THE SAME,” which claims the benefit of U.S. provisional patent application 63/299,164, filed Jan. 13, 2022, titled “Oxidized Bacterial Cellulose Separator for Batteries and Method for Producing the Same,” the entireties of the disclosures of which are hereby incorporated by this reference.

### STATEMENT REGARDING FEDERALLY SPONSORED RESEARCH

This invention was made with government support under 2103582 awarded by the National Science Foundation. The government has certain rights in the invention.

### TECHNICAL FIELD

Aspects of this document relate generally to battery separators.

### BACKGROUND

Countless technologies are fueling the demand for batteries that provide more power in a smaller package. Elemental lithium has the highest theoretical specific capacity and the lowest negative potential, making it the most attractive battery anode material. Lithium-metal batteries can deliver an energy density significantly higher than that of lithium-ion batteries. Instead of the conventional graphite anode of lithium-ion batteries, lithium-metal batteries use Li metal as the anode. This Li-metal anode is sometimes matched with a cathode made of conventional oxide materials, but can also be paired with a cathode based on more exotic sulfur and oxygen compounds.

However, the use of a lithium-metal anode introduces a number of problems that need to be overcome before Li-metal batteries are practical for widespread use. A major problem is the formation of lithium dendrites and the associated unstable solid electrolyte interface (SEI) layer. The lithium dendrites can penetrate the battery separator and short out the cathode and anode, raising severe safety concerns. These dendrites also can detach from the anode and form dead lithium after being encapsulated by insulating SEI. Moreover, the dendrite detachments expose fresh lithium to the electrolyte, causing a continuous reaction between lithium and the electrolyte and resulting in fast capacity loss and low Coulombic efficiency during battery operation.

Depending on battery chemistry, the choice of paring cathode may exacerbate these issues by introducing additional side reactions. For example, lithium-sulfur batteries employ sulfur as the cathode material, offering the desirable combination of a large specific capacity and low cost. However, in the stepwise conversion chemistry between S₈ and Li₂S, many intermittent lithium polysulfide species are formed. Except for the short-chain Li₂S₂ and the final product Li₂S, the long-chain polysulfide intermediates are highly soluble in currently available ether-based lithium-sulfur battery electrolytes. These intermediates can easily diffuse out of the cathode matrix to the anode side and then be reduced by the lithium metal. The shuttling of these polysulfides between the cathode and the anode gives rise to capacity fading, enhanced corrosion of the lithium anode, and self-discharge.

### SUMMARY

According to one aspect, a method for fabricating a separator for a lithium-based battery includes oxidizing cellulose fibrils through a TEMPO oxidation to form oxidized cellulose having carboxylic functional groups, the cellulose being a bacterial cellulose. The method further includes decorating the oxidized cellulose with nanoparticles composed of an oxide material by introducing a precursor solution to the oxidized cellulose that reacts with hydroxyl groups of the oxidized cellulose while preserving the carboxylic functional groups of the oxidized cellulose, causing the nanoparticles to nucleate on the surface of the oxidized cellulose. The method also includes forming the nanoparticle-decorated oxidized cellulose into a film to become the separator for the lithium-based battery.

Particular embodiments may comprise one or more of the following features. The oxide material may be SiO₂. The precursor solution may be tetraethyl orthosilicate (TEOS). The oxide material may be one of TiO₂, Ti₄O₇, ZnO, Al₂O₃, MoO₃, V₂O₅, VO₂, V₂O₃, H-doped VO₂, MnO₂, SnO₂, NiO, ZnAl₂O₄, ZnMgO, and BaTiO₃. The lithium-based battery may be one of a lithium-metal battery and a lithium-sulfur battery.

According to another aspect of the disclosure, a method for fabricating a separator for a lithium-based battery includes oxidizing cellulose fibrils to form oxidized cellulose having carboxylic functional groups, decorating the oxidized cellulose with nanoparticles, and forming the nanoparticle-decorated oxidized cellulose into a film to become the separator for the lithium-based battery.

Particular embodiments may comprise one or more of the following features. The cellulose may be a bacterial cellulose. The cellulose fibrils may be oxidized through a TEMPO oxidation. Decorating the oxidized cellulose with nanoparticles may include introducing a precursor solution to the oxidized cellulose that reacts with hydroxyl groups of the oxidized cellulose while preserving the carboxylic functional groups, causing the nanoparticles to nucleate on the surface of the oxidized cellulose. The nanoparticles may be composed of an oxide material. The oxide material may be SiO₂. The precursor solution may be tetraethyl orthosilicate (TEOS). The oxide material may be one of TiO₂, Ti₄O₇, ZnO, Al₂O₃, MoO₃, V₂O₅, VO₂, V₂O₃, H-doped VO₂, MnO₂, SnO₂, NiO, ZnAl₂O₄, ZnMgO, and BaTiO₃. The nanoparticles may be composed of a nitride material. The nitride material may be one of AlN, TiN, VN, and O-doped VN. The nanoparticles may be composed of a sulfide material. The sulfide material may be one of TiS₂, MoS₂, NiCo₂S₄, NiCo₂(O—S)₄, V₂S₅, and O-doped Sb₂S₃. The nanoparticles may be composed of a single atom catalyst based on one of as Fe, V, Mo, Co, Ti, and Ge. The lithium-based battery may be a lithium-metal battery. The lithium-based battery may be a lithium-sulfur battery.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1 is a schematic view of a process for producing a separator composed of oxidized bacterial cellulose decorated with SiO₂ nanoparticles;

FIG. 2 is a flowchart for a method for producing a composite film composed of oxidized cellulose decorated with nanoparticles;

FIG. 3A is a SEM image of a specific embodiment of oxidized bacterial cellulose;

FIGS. 3B and 3C are SEM images of the o-BC of FIG. 3A after decoration with SiO₂ nanoparticles;

FIG. 3D shows the results of heating of decorated and undecorated oxidized bacterial cellulose films to different temperatures to demonstrate thermal stability;

FIG. 3E shows the electrolyte uptake capacity and the electrolyte wettability of decorated and undecorated oxidized bacterial cellulose;

FIGS. 3F and 3G show Nyquist plots and I-t curves for different separator films;

FIG. 4A is a voltage over time plot showing the Li plating and striping result when cycling three different separator films in symmetric Li//Li cells;

FIGS. 4B-4E are SEM images of the three separator films of FIG. 4A after Li stripping and plating cycling;

FIG. 4F is a voltage over time plot for a symmetric Li//Li cell with an o-BC/SiO₂ separator;

FIG. 4G shows different charge-discharge voltage profiles under different current densities for the Li//Li cell of FIG. 4F;

FIG. 4H is a voltage over time plot for the Li//Li cell demonstrating long cycling stability;

FIG. 5A shows the cycling performance of a Li//Cu asymmetric cell with three different separators;

FIG. 5B shows the voltage profiles for the three cells of FIG. 5A;

FIG. 5C shows the voltage profiles of the o-BC/SiO₂ based cell at different current densities in different cycles;

FIG. 5D shows the Coulombic efficiency of the o-BC/SiO₂ based cell;

FIGS. 6A-6B show CV curves and EIS Nyquist plots for LSB cells with three different separators;

FIGS. 6C-6D show the open-circuit voltage (OCV) over time and as a function of specific capacity, for LSB cells with three different separators;

FIG. 6E shows the cycling performance of different separator based LSBs; and

FIGS. 6F and 6G show CV curves and cycling performance of a Li//LiFePO₄ cell with C-2400 or o-BC/SiO₂ separators, respectively.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Countless technologies are fueling the demand for batteries that provide more power in a smaller package. Elemental lithium has the highest theoretical specific capacity (3861 mAh g⁻¹) and the lowest negative potential (−3.04 V vs. standard hydrogen electrode), making it the most attractive battery anode material. Lithium-metal batteries can deliver an energy density significantly higher than that of lithium-ion batteries. Instead of the conventional graphite anode of lithium-ion batteries, lithium-metal batteries use Li metal as the anode. This Li-metal anode is sometimes matched with a cathode made of conventional oxide materials, but can also be paired with a cathode based on more exotic sulfur and oxygen compounds.

However, the use of a lithium-metal anode introduces a number of problems that must be overcome before Li-metal batteries are practical for widespread use. A major problem is the formation of lithium dendrites and the associated unstable solid electrolyte interface (SEI) layer. The lithium dendrites can penetrate the battery separator and short out the cathode and anode, raising severe safety concerns. These dendrites also can detach from the anode and form dead lithium after being encapsulated by insulating SEI. Moreover, the dendrite detachments expose fresh lithium to the electrolyte, causing a continuous reaction between lithium and the electrolyte and resulting in fast capacity loss and low Coulombic efficiency during battery operation.

Depending on battery chemistry, the choice of paring cathode may exacerbate these issues by introducing additional side reactions. For example, lithium-sulfur batteries employ sulfur as the cathode material, offering the desirable combination of a large specific capacity (1675 mAh g⁻¹) and low cost. However, in the stepwise conversion chemistry between S₈ and Li₂S, many intermittent lithium polysulfide species are formed. Except for the short-chain Li₂S₂ and the final product Li₂S, the long-chain polysulfide intermediates are highly soluble in the currently available ether-based lithium-sulfur battery electrolyte. These intermediates can easily diffuse out of the cathode matrix to the anode side and then be reduced by the lithium metal. The shuttling of these polysulfides between the cathode and the anode gives rise to capacity fading, enhanced corrosion of the lithium anode, and self-discharge.

A number of different strategies have been suggested to minimize or eliminate the formation of these problematic lithium dendrites. Dendrite formation is correlated to a large local Li+ flux density. Therefore, for a given nominal charging current density, reduction of the Li+ flux density by the adoption of 3D anode structures, or elimination of localized high flux “hot spots” by homogenizing Li+ flux are two potentially useful strategies. Other approaches include establishing a stable SEI layer on lithium metal surface, constructing functional layers on lithium to shield its side-reactions, and/or changing the electrolyte chemistry. Specific examples include, but are not limited to, using new solvent systems such as ether-based systems and ionic liquids which possess better compatibility with lithium metal, adding additives to facilitate the formation of robust SEI via additive self-decomposition or its interaction with Li anode, constructing artificial SEI by directly coating an ionic conductive layer on Li metal, introducing 3D lithium hosts to reduce the flux concentration, providing lithium nucleation sites and regulating lithium deposition process, and fabricating a functionalized separator to facilitate the Li+ transfer and Li redeposition process. Unfortunately, these strategies tend to be complicated and/or will require processes that will not bring lithium-sulfur batteries any closer to being commercially viable for widespread use.

Of the aforementioned approaches, functionalizing the separator is appealing for its relative simplicity. Separator engineering can address the Li dendrite issues associated with the Li metal anode. It also can curb the polysulfides shuttling effect and resulting self-discharging of the battery. However, building this kind of multi-functionalized separator is quite challenging due to the complicated structures and synthesis methods involved.

Contemplated herein is an oxidized bacterial cellulose separator that has been functionalized with nanoparticles to serve as a separator for lithium-based (e.g., Li-metal batteries, Li-sulfur batteries, etc.). The contemplated oxidized bacterial cellulose separator with nanoparticles has been shown to generate a smooth Li+flux and regulate the Li deposition, while also curbing the polysulfide shuttling process. Advantageous over conventional battery separators, the contemplated separator can run at much higher temperatures.

According to various embodiments, the contemplated separator comprises bacterial cellulose (BC) decorated with nanoparticles, such as non-metal and metal oxides. The intrinsic function of the separator is to isolate the active materials of the cathode and the anode. Natural polymers, particularly cellulose, have attracted attention for use as battery separators because of their good mechanical properties, outstanding thermal and chemical stability, excellent wettability, and low cost. For battery separators, bacteria cellulose (BC) is superior to plant-derived celluloses because the higher purity and better crystallinity of BC vests it with superior mechanical, thermal, and chemical properties.

The dense O-containing moieties of BC enable the formation of non-metal or metal oxide nanoparticles on the BC nanofibers. According to various embodiments, strong interaction between Li+ and the nanoparticles (or BC) facilities the homogenization of the Li+ flux, stabilizing lithium stripping/plating. In some embodiments, oxygen-related bonds also effectively absorb polysulfide species, suppressing the shuttling process. As will be discussed below, the performance of various specific, non-limiting examples of the separator contemplated herein have been experimentally verified to be superior to conventional separators (e.g., Celgard 2400, etc.) and pristine, non-oxidized bacterial cellulose.

It should be noted that while the following disclosure is done in the context of an oxidized BC separator decorated with SiO₂ nanoparticles (hereinafter “o-BC/SiO₂ separator” or “separator”), other embodiments may utilize different materials for the nanoparticles, such as metal and non-metal oxides. These materials include, but are not limited to, TiO₂, Ti₄O₇, ZnO, Al₂O₃, MoO₃, V₂O₅, VO₂, V₂O₃, H-doped VO₂, MnO₂, SnO₂, NiO, as well as ZnAl₂O₄, ZnMgO, BaTiO₃ and other transition metal oxides. In addition to nanoparticles, in some embodiments, other nanoscale structures and architectures may be utilized including, but not limited to, nanowires, nanofibers, and/or nanorods of TiO₂, ZnO and other materials. Metal nitrides, sulfides, phosphides, and their alloys, such as TiN, VN, AlN, TiS₂, MoS₂, NiCo₂S₄, NiCo₂(O—S)₄, V₂S₅, CoP, O-doped Sb₂S₃, O-doped VN, O-doped CoP, may also be used in some embodiments. Transition metal such as Fe, V, Mo, Co, Ti, and Ge, based single atom catalysts, may also be used in some embodiments.

In still other embodiments, the separator may be coated with polydopamine (PDA). In a specific embodiment, 20-30 g of bacterial cellulose (BC) sheet may be impelled in 100 mL of DI water to form a dispersed BC nanofiber suspension. Polydopamine hydrochloride (i.e., 2 gL⁻¹) and 10 mM tris-HCl solution (i.e., pH=8) may then be used for functionalizing the BC. It may be added to the cellulose solution under vigorous stirring and left for 24 hours, for PDA polymerization.

Furthermore, while some embodiments utilize bacterial cellulose, it should be noted that other plant cellulose-based fibrils may also be used, according to various embodiments. The contemplated methods for fabricating the contemplated o-BC separator comprising nanoparticles may be adapted for nanoparticles of other nonmetal or metal oxides/sulfide materials, which may also be introduced uniformly onto the BC fibers, leading to better structure and composition for the separator for use in various batteries, including but not limited to Li-metal and Li-sulfur batteries.

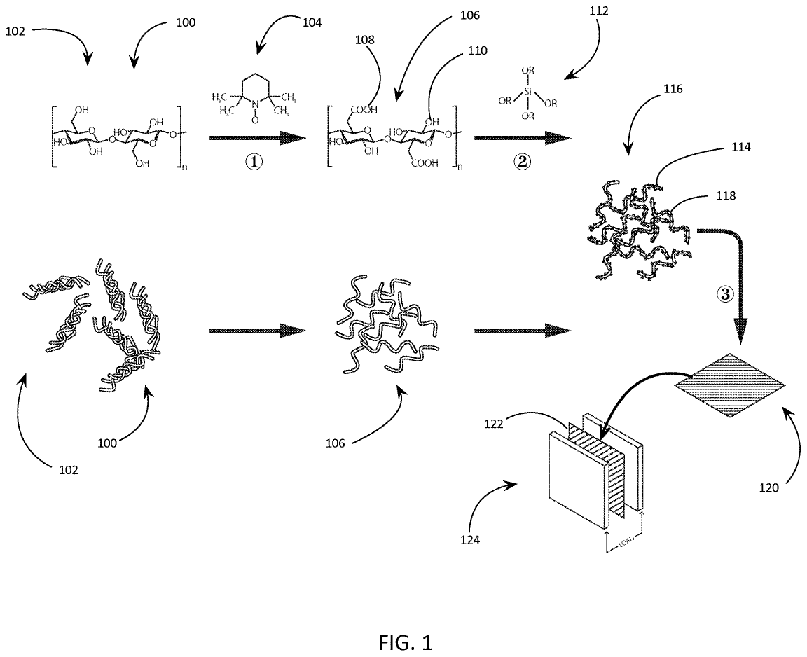

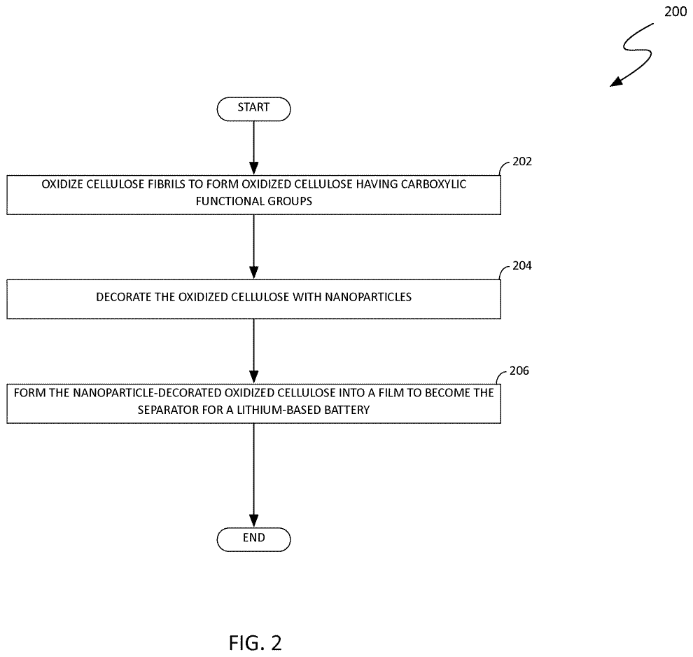

FIG. 1 shows a schematic depiction of a non-limiting example of a method for producing a specific embodiment of the contemplated separator 122. Specifically, FIG. 1 shows the process for producing a composite film 120 composed of bacterial cellulose 102 that has been oxidized and decorated with SiO₂ nanoparticles 114. FIG. 2 shows a flowchart for a method 200 for producing various embodiments of the contemplated separator 122 including, but not limited to, the o-BC/SiO₂ separator 122 shown in FIG. 1.

First, cellulose fibrils 100 are oxidized to form oxidized cellulose 106 having carboxylic functional groups 108 (step 202). See ‘circle 1’ of FIG. 1. In some embodiments, including the non-limiting example shown in FIG. 1, the cellulose 100 is a bacterial cellulose 102. In some embodiments, the bacterial cellulose 102 begins in pellicle form, and may be produced via a fermentation process, as is known in the art. In a specific embodiment, the BC pellicles are subsequently washed in DI water, then boiled in 0.5 M KOH solution for 1 hour to remove impurities. The purified pellicles are then washed in DI water again until a pH of ~7.0 is attained. In other embodiments, the bacterial cellulose 102 may be sourced in a different form or in a different process. In still other embodiments, other cellulose 100 may be used.

The more dispersed the cellulose fibrils 100 are in solution, the more uniform the decoration of the fibrils 100 with nanoparticles 114 will be. In some embodiments, the purified BC pellicles may be minced into a pulp prior to oxidation. According to various embodiments, the cellulose fibrils 100 (e.g., pulped bacterial cellulose 102, etc.) may be oxidized through exposure to 2,2,6,6-tetramethylpiperidine-1-oxyl (TEMPO), as shown in ‘circle 1’ of FIG. 1. The TEMPO oxidation process serves to selectively convert the C₂-hydroxyl functional groups of the cellulose fibrils 100 into carboxylic functional groups 108. The TEMPO oxidation process can also partly hydrolyze the thick fibrils into microfibrils, resulting in better dispersion in water and ethanol. In other embodiments, other oxidation processes and solutions may be used; the process used depends, in part, on the nature of the cellulose 100 being oxidized.

In a specific, non-limiting example, 30 g of pulped bacterial cellulose 102 is first dispersed into 100 mL of DI water under strong stirring, and then 0.016 g of TEMPO 104 and 0.1 g of NaBr are added into the solution, sequentially. After they have dissolved completely, 5 mL of 12% NaClO solution is added dropwise into the mixture. During the reaction process, the solution's pH may be adjusted with 0.5 M NaOH to roughly 10. The oxidation reaction is carried out for 5 hours and then quenched by pouring 5 mL of ethanol directly into the solution. The oxidized bacterial cellulose 106 (hereinafter “o-BC”) is then collected via centrifuge. Continuing with the specific, non-limiting example, the collected o-BC 106 is then washed using 0.5 M HCl solution, DI water, and ethanol until the pH reaches 7.0. Because of the large carboxylic functional group 108 concentration, the collected o-BC 106 may be homogeneously dispersed into ethanol or DI water, according to various embodiments.

Next, the oxidized cellulose 106 (e.g., o-BC 106, etc.) is decorated or functionalized with nanoparticles 114 (step 204). See ‘circle 2’ of FIG. 1. According to various embodiments, the distribution of the nanoparticles 114 can be significantly improved after introducing extrinsic functional groups (i.e., carboxylic functional groups 108, etc.) on the o-BC 106 as a result of the interaction between the functional groups and nanoparticle precursors (i.e., precursor solution 112), as well as thinner bacterial cellulose fiber diameters. As shown schematically in FIG. 1, this mechanism can be used to produce evenly distributed nanoparticle-modified bacterial cellulose composites, hereinafter referred to as decorated cellulose 116, where the precursor solution 112 will react with the hydroxyl groups 110 and cause nanoparticles 114 to nucleate on the surface 118 of the oxidized cellulose nanofibrils 106, while the carboxylic functional groups 108 are preserved. Advantageously, these preserved carboxylic functional groups 108 serve as another polysulfide shuttling barrier because of the direct repulsive interaction between the carboxylic functional groups 108 and problematic polysulfides.

As previously mentioned, in some embodiments, the nanoparticles 114 may be composed of one or more oxide materials. Examples include, but are not limited to, SiO₂, TiO₂, ZnO, Al₂O₃, MoO₃, V₂O₅, SnO₂, NiO, ZnAl₂O₄, ZnMgO, and BaTiO₃. As shown in FIG. 1, in a specific embodiment the nanoparticles 114 may be composed of SiO₂, created through the introduction of tetraethyl orthosilicate (TEOS) as the precursor solution 112. In other embodiments, the nanoparticles 114 may be composed of a nitride material including, but are not limited to, AlN. In still other embodiments, the nanoparticles 114 may be composed of a sulfide material. Examples include, but are not limited to, TiS₂ and V₂S₅.

Benefiting from the oxidation process implemented on the pristine bacterial cellulose 102, the introduced carboxylic functional groups 108 effectively modify the nanoparticle 114 growth process, advantageously resulting in a uniform coating on the o-BC 106. In a specific, non-limiting example, the formation of SiO₂ nanoparticles 114 begins with dissolving 400 μL of TEOS into 50 mL of an ethanol solution of o-BC 106. After stirring for thirty minutes, 1.0 mL of ammonium hydroxide is added dropwise into the mixture. The resulting decorated cellulose 116 (i.e., the o-BC/SiO₂ composite) is collected via centrifuge, and then washed sequentially with DI water and ethanol, and then dispersed into 50 mL of ethanol. The decorated cellulose 116 is then separated by filtrating 25 mL of the above mixture through a PTFE membrane (e.g., 44 mm diameter with a 0.22 μm pore size).

After the nanoparticles 114 are formed, the resulting decorated cellulose 116 material is formed into a composite film 120 (step 206) to become the separator 122 for the lithium-based battery 124. See ‘circle 3’ of FIG. 1. In a specific, non-limiting example, the material may be sandwiched between two glass slides and then dried in a vacuum oven at 80° C. for twelve hours. The resulting o-BC/SiO₂ composite film 120 has controllable thickness in the range of 5-50 micrometers, according to various embodiments. Other embodiments may employ other processes known in the art for fabricating thin films from fibril-like materials.

As previously mentioned, the resulting film 120 is advantageous for use as a separator 122 in a lithium-based batteries 124 including, but not limited to, lithium-metal batteries and lithium-sulfur batteries.

The following discussion explores the performance and characterization of a specific, non-limiting embodiment, specifically the o-BC/SiO₂ embodiment discussed above. However, it is important to note that other embodiments may employ different cellulose 100 and/or different materials for the nanoparticle 114 or other nanoscale structures decorating the oxidized cellulose 106. The following discussion focused on the characterization and properties of a specific embodiment using bacterial cellulose 102 and SiO₂ nanoparticles 114 derived from TEOS should not be interpreted as a limitation on the range of alternative embodiments. The separators and methods contemplated herein may be adapted for use with other types of batteries and/or materials, according to various embodiments.

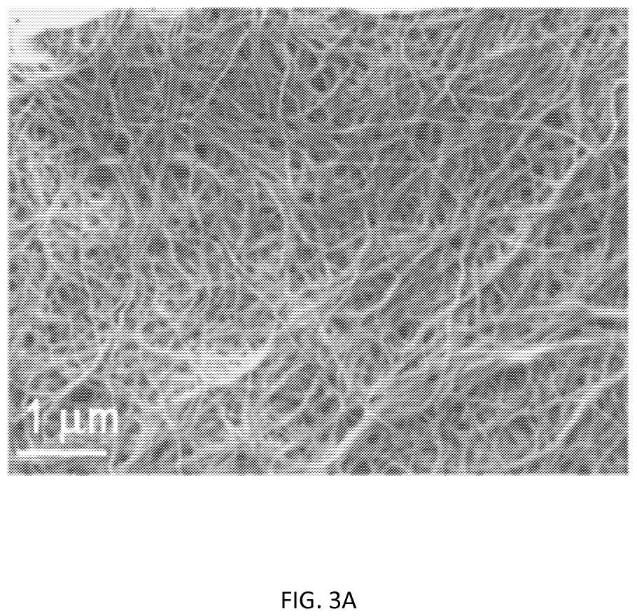

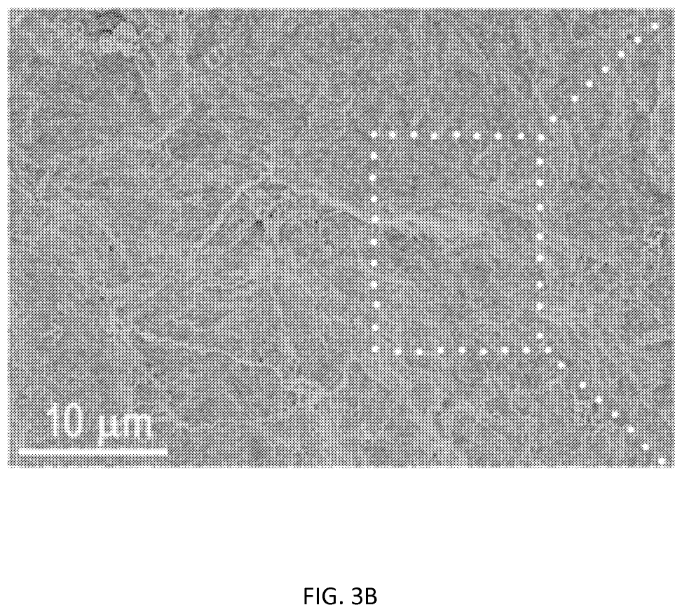

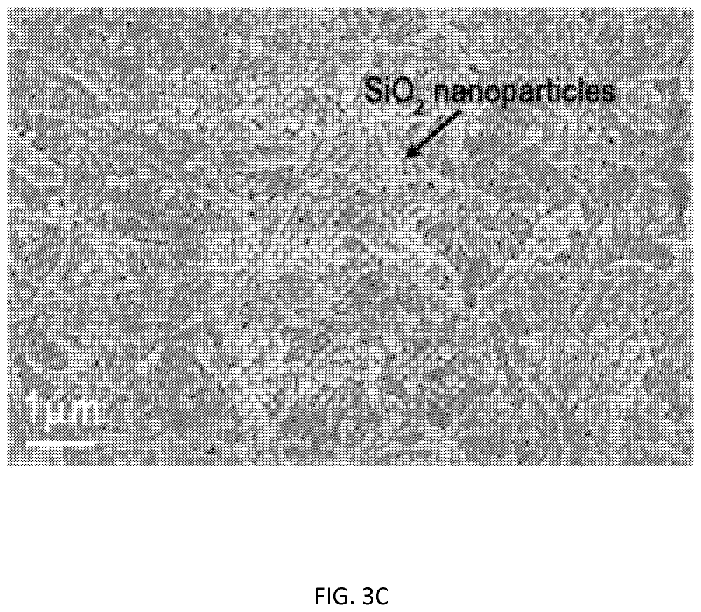

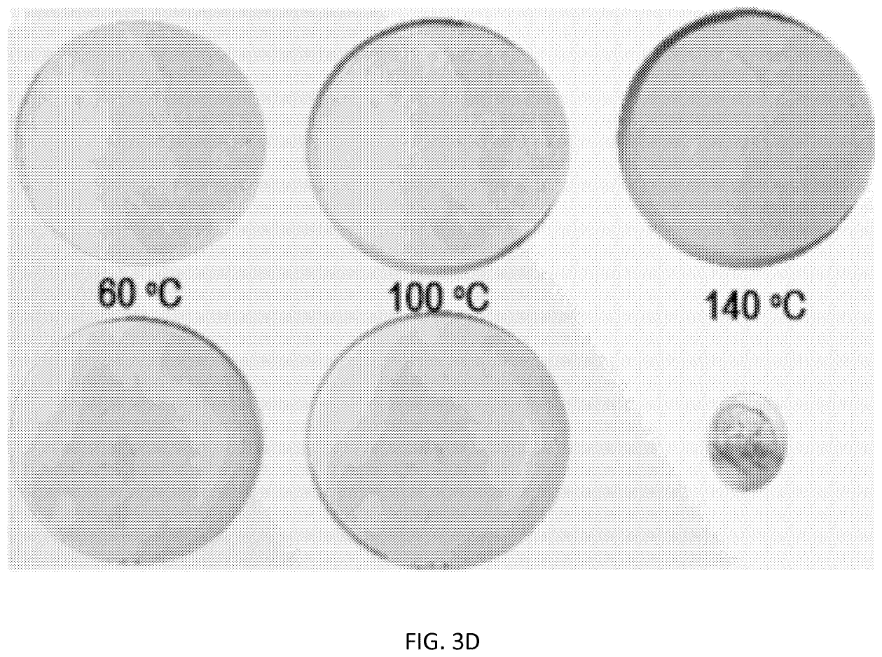

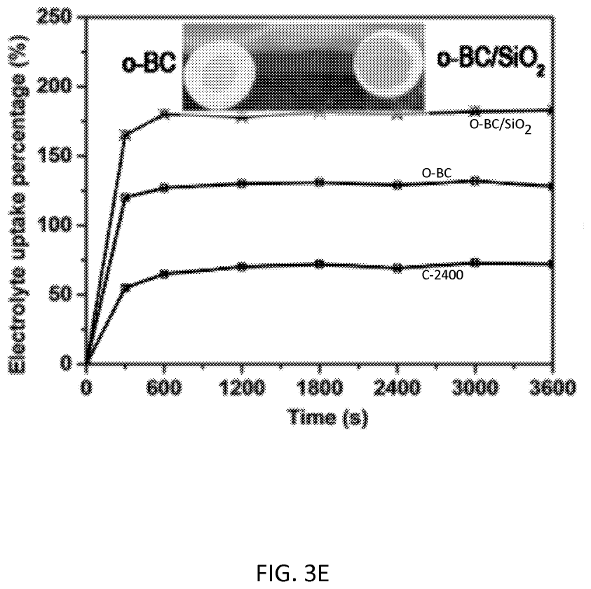

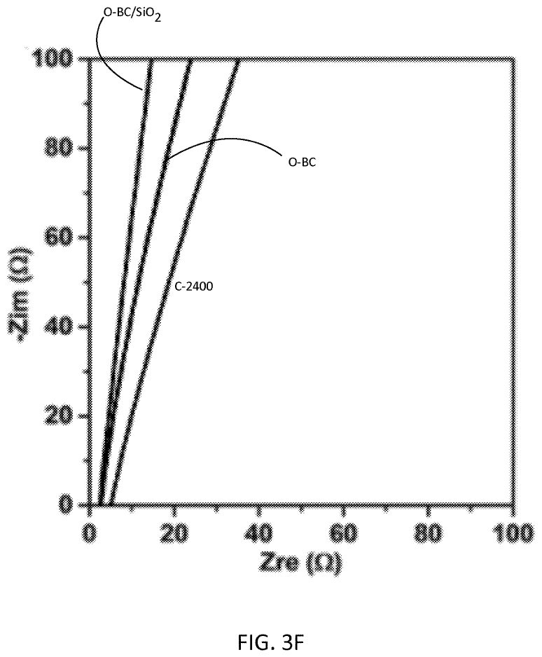

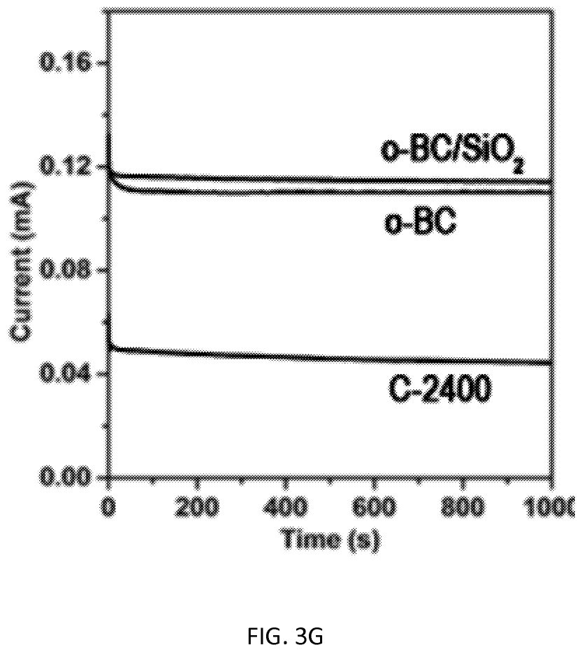

As will be discussed below, for the purposes of characterization in a specific embodiment, the same process was used to prepare an o-BC film without SiO₂ nanoparticles 114. FIG. 3A is a SEM image of a specific embodiment of o-BC 106. The crosslinked structure guarantees the flexibility of the resulting thin film. As shown in FIGS. 3B and 3C (SEM images of o-BC/SiO₂), the ~100 nm SiO₂ nanoparticles 114 uniformly decorate the bacterial cellulose 102 nanofibrils in this specific non-limiting example.

Samples of the specific, non-limiting example of the contemplated o-BC/SiO₂ film (i.e., the decorated cellulose 116 of FIG. 1) described above were fabricated using the disclosed process, as well as samples of o-BC 106 without the nanoparticles 114, for the purposes of testing and characterization. The following is a discussion of the characterization and performance of that specific embodiment, and should not be construed to be a limitation of either the characterization methods, or the actual characteristics and/or performance of other embodiments of the contemplated o-BC/SiO₂ battery separator. Those skilled in the art will recognize that the tests and measurements discussed below may be performed in other ways, as is known in the art.

Samples of the specific embodiment of the contemplated separator film 120 were synthesized. The morphological features of the samples were studied using a field emission scanning electron microscope (i.e., FEI XL 30 FE-SEM). X-ray diffraction patterns of the samples were recorded using a Rigaku MiniFlex 6G diffractometer equipped with a Cu-Kα radiation source. Differential scanning calorimetry was conducted on a LABSYS EVO instrument. To measure the Li+ionic conductivity in a separator 122, it was first soaked in the blank electrolyte (1 M LiTFSI in 1:1 DOL/DME solution), and then sandwiched between two stainless steel spacers and sealed in a coin cell.

Electrochemical impedance spectroscopy (EIS) testing was performed to obtain the resistance, and the ionic conductivity was calculated by using the equation

$$σ = \frac{l}{RS} ,$$

where l is the thickness of the separator 122, R is the resistance read from Nyquist plot, and S is the area of the separator 122. The transference number t⁺ was calculated using the equation t⁺=Iₛ (V−IₒRₒ)/[Iₒ(V−IₛRₛ)], where V is the applied DC voltage (10 mV), Iₒ and Iₛ are the initial and steady-state currents, respectively, which are read from the Chronoamperometry curves. Rₒ and Rₛ are the interfacial resistances before and after DC polarization, respectively, which are obtained from EIS curves.

Li//Li symmetric coin-type cells (e.g., CR2400) were fabricated by employing lithium plates as both the positive and the negative electrodes, using a conventional separator (i.e., Celgard 2400, hereinafter C-2400) in some and the BC-based film 120 as the separator 122 in others. The cell electrolyte for this specific embodiment is made with 1 M bis(trifluoromethane)sulfonamide lithium salt (LiTFSI) dissolved in a 1:1 v/v % mixture of 1,3-dioxolane (DOL)/dimethylethane (DME) solution with 1 wt % LiNO₃. Cyclic voltammetry (CV) and EIS (i.e., 0.1-100 kHz with an AC voltage amplitude of 10 mV) tests were carried out on a Bio-logic SP-150 electrochemical workstation. The lithium stripping and plating cycling were recorded on a battery tester (i.e., LANHE, CT2001A). Li//Cu asymmetric cells were also characterized using a similar configuration, except a Cu foil was used for the positive electrode.

Safe operation at high temperatures is a crucial requirement of the battery separator. The commercial Celgard membranes can only endure a temperature up to ~120° C. before dangerous fault modes become prevalent during operation. The o-BC-based films were tested at elevated temperatures in an oven and the results are exhibited in FIG. 3D. Specifically, FIG. 3D provides a thermal stability comparison between o-BC/SiO2 (the top line) and C-2400. The o-BC 106 (not shown) and o-BC/SiO2 films maintain structural integrity (i.e., shape and dimensions) when the temperature reaches 140° C. while the commercial C-2400 separator film melts at this temperature. To quantitatively characterize the chemical changes at elevated temperatures, a differential scanning calorimetry (DSC) method was used. The C-2400 separator shows a large endothermic peak located at ~150° C., which is attributed to the polypropylene melting. In contrast, the BC-based polymer films endured temperatures as high as ~350° C. before evidence for melting or decomposition was observed. These results suggest that the incorporation of bacterial cellulose 102 in batteries could enable safe operation at much higher temperatures than can be achieved with the current C-2400 separator, according to various embodiments.

The electrolyte wettability and electrolyte uptake capacity are also key parameters used to access the potential of a film 120 for use as a battery separator 122. As shown in FIG. 3E, both o-BC 106 (i.e., a 25 μm thick o-BC film) and o-BC/SiO₂ 116 (i.e., a 30 μm thick o-BC/SiO₂ film) films absorb more electrolyte than C-2400 (i.e., a 25 μm thick C-2400 film). A further advantage is that the wettability of o-BC 106 can be improved significantly after being composited with SiO₂ nanoparticles 114 (see inset of FIG. 3E).

The Li+ ionic conductivity and transference number were also measured. The experimental results are presented in FIG. 3F (Nyquist plots), and FIG. 3G (I-t curves for the three different separator films). Separators 122 with surface functional groups such as oxygen-or nitrogen-containing groups have stronger binding energy to Li+ (e.g., binding energy between carbonyl and Li+ is ~3.08 eV) than bare separators. The Li+ conductivities through o-BC 106 (0.36 mS cm⁻¹) and o-BC/SiO2 116 (0.39 mS cm⁻¹) films 120 are higher than through C-2400 (0.23 mS cm⁻¹). This results from the high Li+ affinity provided by the oxygen functional groups to both o-BC 106 and SiO₂. Even though the Li+ transference number of o-BC 106 based films (0.63 for the o-BC/SiO₂ 116 film and 0.65 for the o-BC 106 one) is smaller than that of C-2400, they are still of sufficient magnitude to make useful separators of lithium-metal batteries.

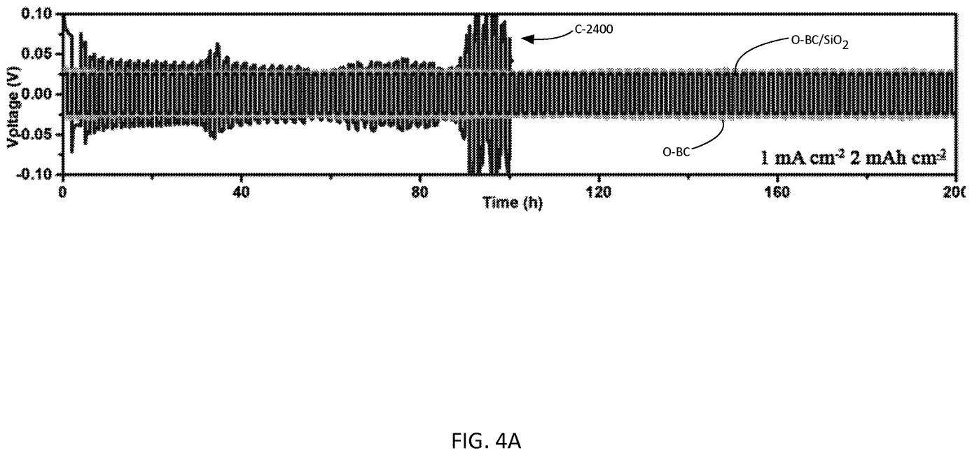

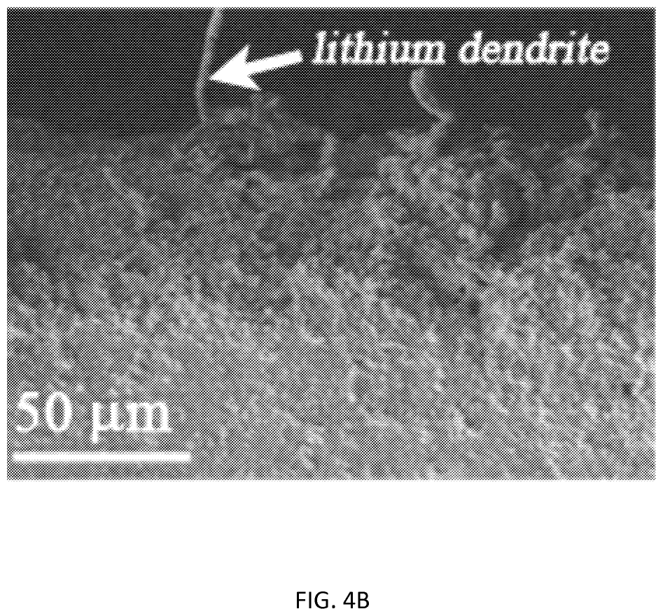

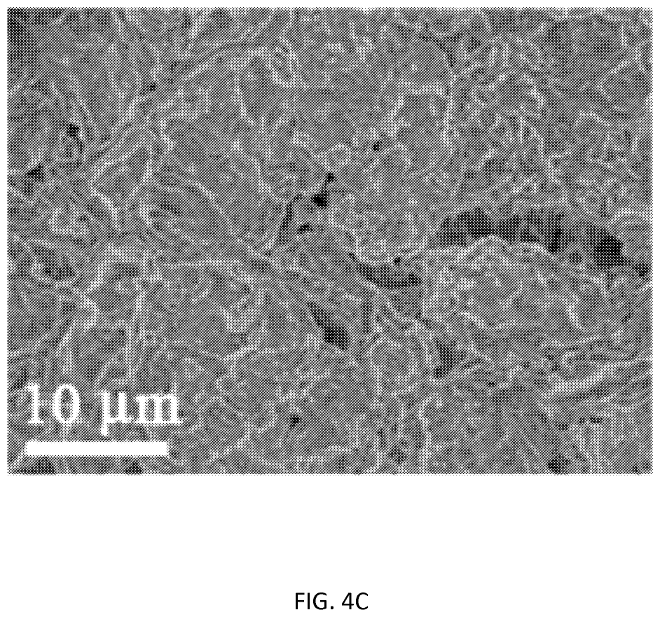

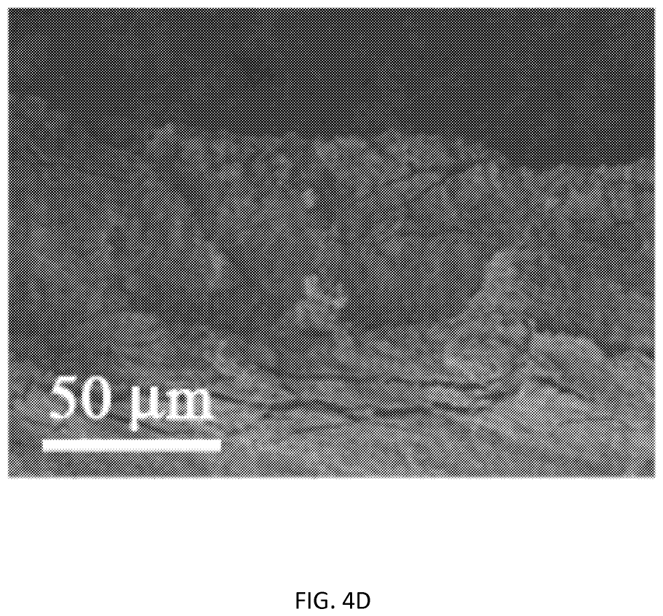

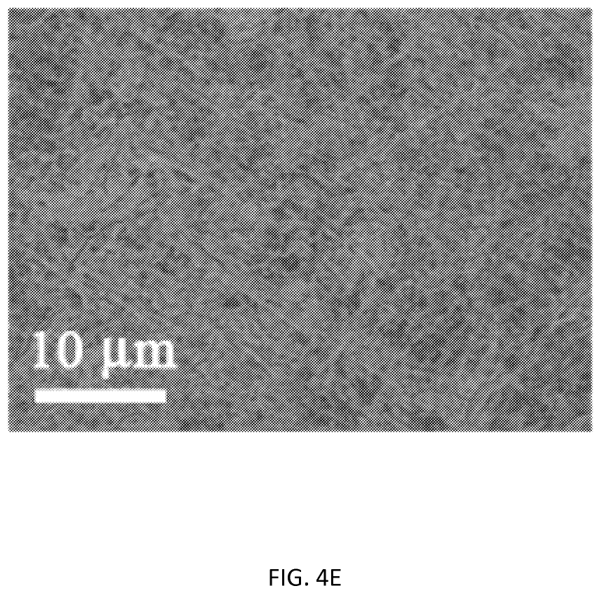

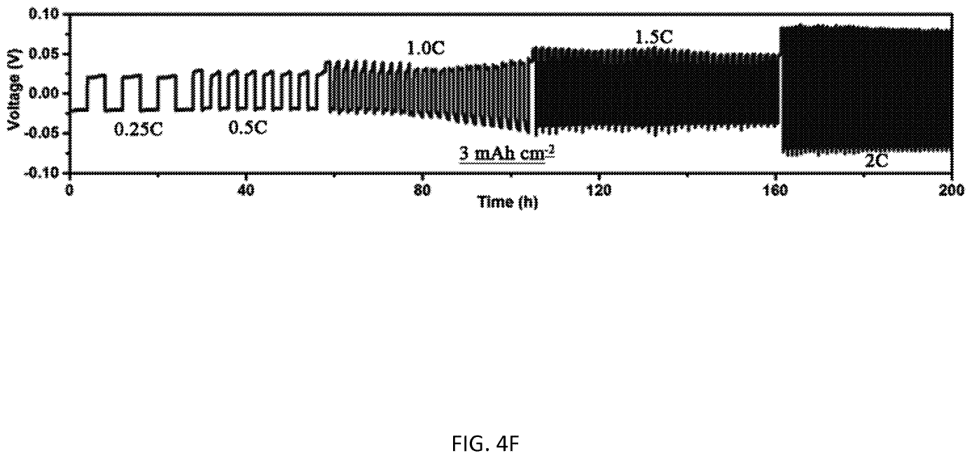

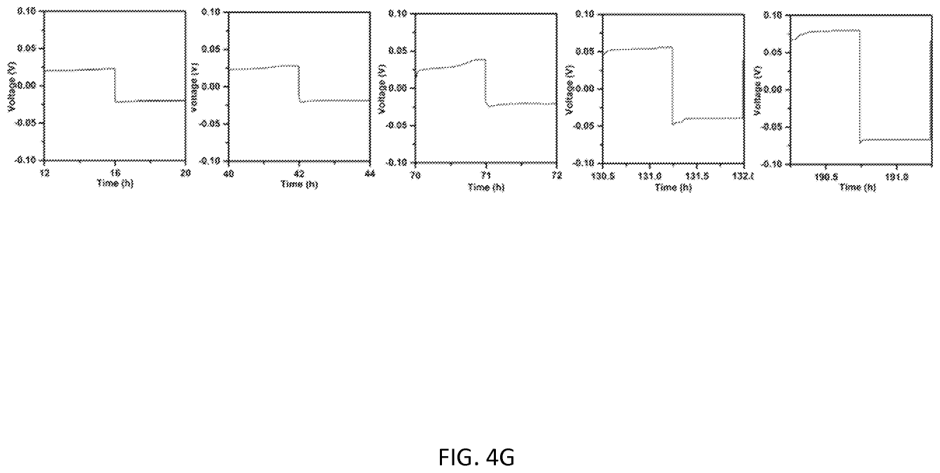

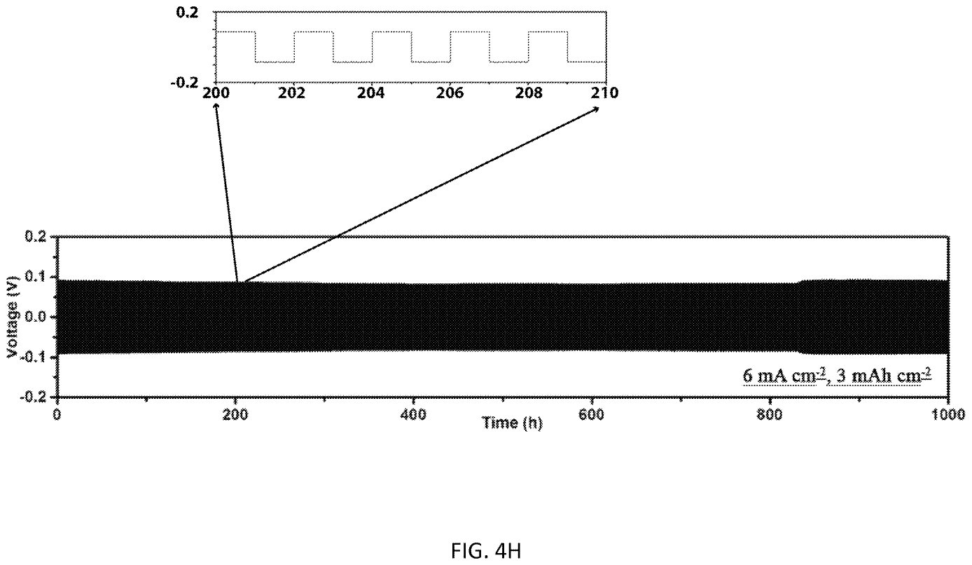

These samples of the specific embodiment discussed above were also characterized in the context of lithium stripping and plating. Galvanostatic cycling of Li//Li symmetric cells was performed to compare the Li stripping and plating efficiency of the commercial C-2400 with the o-BC 106 based separators. A cutoff potential of 120 mV was pre-set. The specific capacity was fixed to 2 mAh cm⁻² and the charge-discharge current density to 1mA cm⁻². The cells with o-BC 106 and o-BC/SiO₂ 116 separators exhibited very low polarization voltages (~27 and ~25 mV, respectively) and stable cycling performance over 200 hours of testing (see FIG. 4A). In contrast, the cell using a C-2400 separator suffered from a higher polarization voltage (~46 mV), which further increased to the pre-set cutoff potential of 120 mV after only 90 hours.

To examine fault mechanisms, cycled cells were disassembled and the structural changes in the lithium electrodes were imaged using an SEM. FIGS. 4B and 4C show the cross-section and surface SEM images of the lithium plate in the symmetric cell with a C-2400 separator after 60 hours of testing. Lithium dendrites are clearly visible, as indicated by the arrow in FIG. 4B. The figure also shows that the surface is rough and granular, the signature of nonuniform Li plating. In contrast, no lithium dendrites are observed in the lithium plate for the Li//Li cell with an o-BC/SiO₂ 116 separator (FIG. 4D). The figure also shows that the surface is smooth and uniform even after 200 hours of cycling. These observations reveal that the contemplated o-BC/SiO₂ separators can more effectively regulate the lithium plating processes and suppress lithium dendrite formation and surface coarsening than the conventional C-2400 separators. The greater performance of the o-BC/SiO₂ 116 separator over C-2400 can be attributed to the higher Li+ion adsorption capability as a result of the stronger interaction between Li+ with o-BC 106 and SiO₂. The ability to absorb Li+ by a separator in a high-rate plating process will adjust and homogenize Li+ flux toward the plated Li electrode, resulting in uniform deposition and preventing dendrites formation and Li metal surface roughening.

Similarly, when using an o-BC 106 film as the separator, the lithium plate after cycling is also dendrite-free and very dense, without the granular and/or porous structure. The abundant oxygen functional groups on the bacterial cellulose 102 are lithiophilic sites and can also serve to regulate and homogenize the Li+ flux, leading to uniform Li deposition on the Li plate.

The stripping/plating rate performance of the Li//Li cell with the o-BC/SiO₂ 116 separator was further evaluated, and the results are presented in FIG. 4F. With the cycling current density increased from 0.75 to 6 mA cm⁻² and maintaining the same specific capacity of 3 mAh cm-⁻², the polarization voltage rises from ~25 to ~90 mV and then maintains a relatively steady value of ~90 mV at 6 mA cm⁻² during cycling. Several representative charge-discharge voltage profiles under different current densities are presented in FIG. 4G. The charge and discharge plateaus are smooth without any spikes for the much higher 6 mA cm⁻² current density, reflecting stable Li+ redox reactions on the surface of the Li electrode.

To further demonstrate the potential of the o-BC 106 separator for fast charge-discharge and long cycling stability, the Li//Li symmetric cell was cycled at the 6 mA cm⁻² current density for 1000 hours. As shown in FIG. 4H, the overpotential maintains a value of ~90 mV for the first 850 hours and then increases to ~100 mV slowly upon cycling up to the 1000th hours. This excellent performance for long cycling times at large current densities demonstrates the contemplated o-BC/SiO₂ 116 film's ability to homogenize the Li-ion flux and prohibit the dendrite formation during the Li plating process. According to various embodiments, these functionalized BC-based separators 122 have the potential to be the choice of Li metal-based battery technology in the future. The polarization voltage stabilizes at ~100 mV at a 6 mA cm⁻² current density for ~200 hours and gradually increases to ~140 mV by the 1000th cycle.

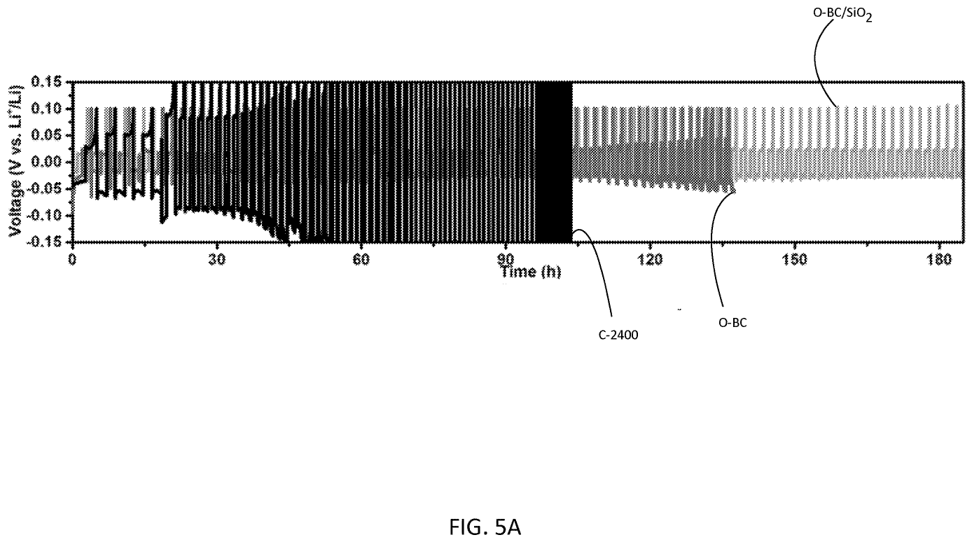

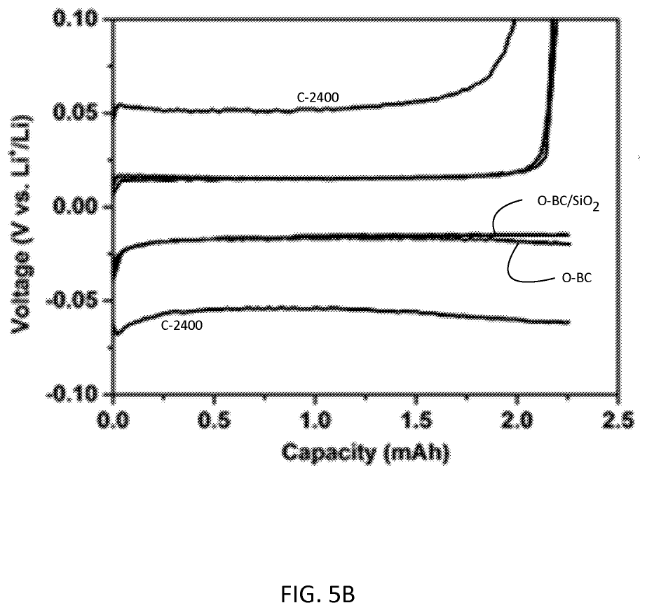

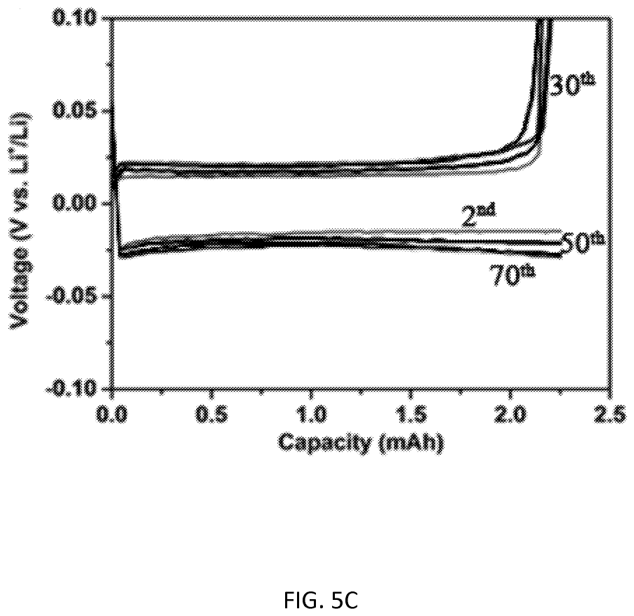

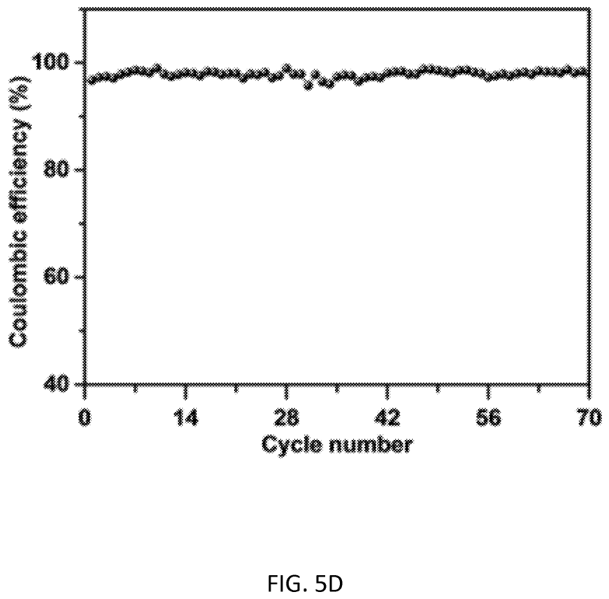

The evaluation of this specific, non-limiting embodiment continued with the assembly of asymmetric cells comprised of a Li foil as the negative electrode, a copper foil as the positive electrode, and the C-2400 or the o-BC 106 based film as the separators. These asymmetric cells were tested to further evaluate the performance of the different separator films. For these tests, the charging cutoff voltage was set to 0.1 V. As shown in FIG. 5A, with the fixed capacity of 2 mAh cm⁻², the C-2400 cell can only survive for a few cycles under a relatively low current density of 1.0 mA cm⁻². Specifically, the C-2400 and o-BC-based cells were cycled at the current density of 1.0 mA cm⁻² at the first five cycles and the o-BC/SiO₂-based cell was cycled at the current density of 2.0 mA cm⁻² from the beginning.

The cell with the o-BC 106 separator exhibits a much longer lifetime, failing after ~130 hours at a current density of 2 mA cm⁻². Overall, the o-BC/SiO₂ 116 separators offer the best performance of these specific non-limiting examples, as it is stable over 180 hours of cycling. The voltage profiles at different capacities of the three cells are compared in FIG. 5B. Cells with o-BC 106 and o-BC/SiO₂ 116 separators have similar polarization potential (~24 mV) which is significantly lower than the C-2400 cell (~50 mV). During cycling, the o-BC/SiO₂ 116 based cell maintained its stability (FIG. 5C), and Coulombic efficiency of around 98.5% was achieved (FIG. 5D).

By incorporating this o-BC/SiO₂ 116 composite separator into the Li//Li symmetric and Li//Cu asymmetric cells for the Li stripping/plating study, lower polarization voltage, higher coulombic efficiency, and much longer lithium stripping/plating cycling stability was observed over cells using either the conventional Celgard 2400 (C-2400) separator or the pristine BC separator. As a result, subsequently fabricated Li//S and Li//LiFePO₄ batteries had markedly improved electrochemical performances. For example, in one embodiment, a LSB cell with 4 mg cm⁻² of sulfur loading can deliver ~1250 mAh g⁻¹ of specific capacity at 0.1 C and maintain 83% capacity after 100 cycles at 0.25 C. The LMB cell based on Li//LiFePO 4 shows high and more stable Coulombic efficiency (~99.5%) while cycling 200 times at 0.2 C.

In addition to the symmetric and asymmetric cells discussed above, two different types of lithium metal batteries were chosen to demonstrate the feasibility of this specific embodiment of the contemplated o-BC/SiO₂ 116 separator. Specifically, a Li//S battery and a Li//LiFePO₄ battery. For the LSB, lithium metal was used as the anode, sulfur loaded in a carbonized BC (cBC) film as the cathode, the C-2400 or the BC-based film as the separator, 1 M bis(trifluoromethane)sulfonamide lithium salt (LiTFSI) with 1 wt % LiNO₃ dissolved in a 1:1 v/v% mixture of 1,3-dioxolane (DOL)/dimethylethane (DME) solution as the electrolyte. For the Li//LiFePO₄ battery, a commercial LiFePO 4/aluminum foil (single side coated, 12 mg cm⁻², MTI corporation) was used as the cathode, 1 M LiPF6 in ethylene carbonate (EC), and ethyl methyl carbonate (EMC) was used as the electrolyte (MTI corporation). Again, this is continuing the discussion of the specific, non-limiting example mentioned above. Other embodiments of the contemplated separators may be adapted into lithium-based batteries using different sizes, materials, and/or electrolytes.

As previously mentioned, in addition to addressing the above Li anode issues, for Li—S batteries, shuttling of lithium polysulfides in Li—S batteries must also be inhibited to prevent low Coulombic efficiency and short battery lifetime. The separator 122 used in LSBs could help to attack this problem by curbing the diffusion of polysulfides. With this in mind, the specific embodiment of the contemplated o-BC 106 and o-BC/SiO₂ 116 films were subjected to polysulfide diffusion experiments. Specifically, the two compartments are isolated by the separator 122, with the left side being 20 mM Li₂S₆ electrolyte and the right side being a blank electrolyte. All the films were shown to have the ability to block polysulfide migration at the beginning. However, polysulfide diffusion across the C-2400 film became obvious after 6 h, resulting in a color change in the left compartment. In contrast, the o-BC 106 and o-BC/SiO₂ 116 films can successfully curb the polysulfide diffusion over 24 hours of testing, a result of the strong interaction between the polysulfides and SiO₂/oxygen functional groups. Without similar active binding sites on C-2400, it can only physically block polysulfides diffusion for a short time.

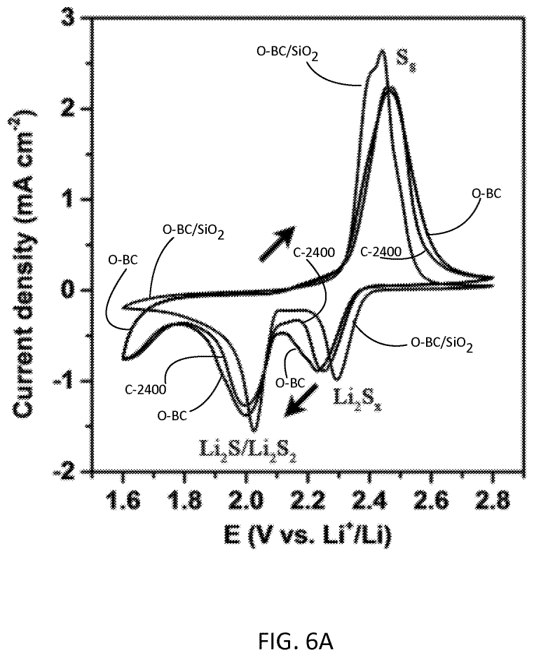

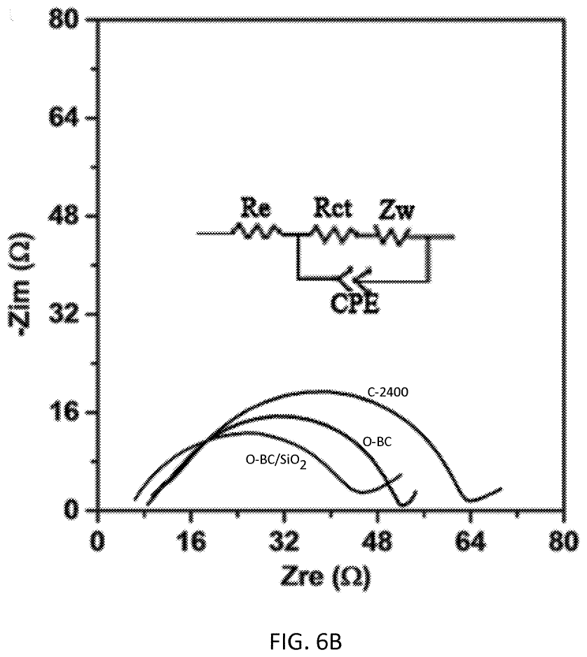

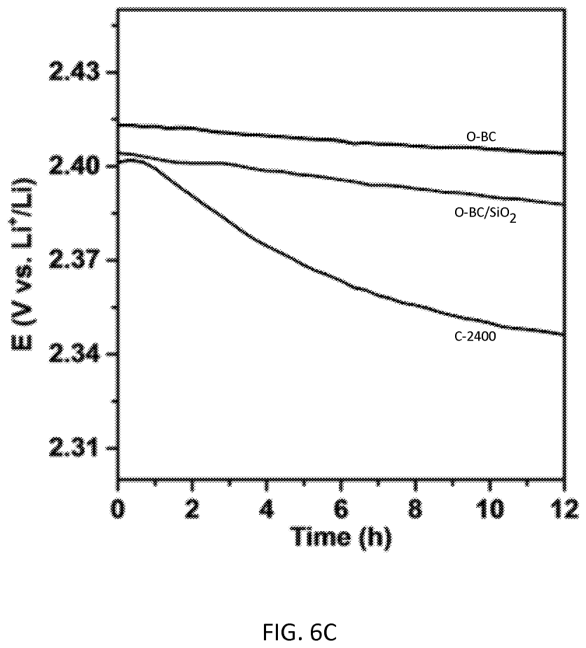

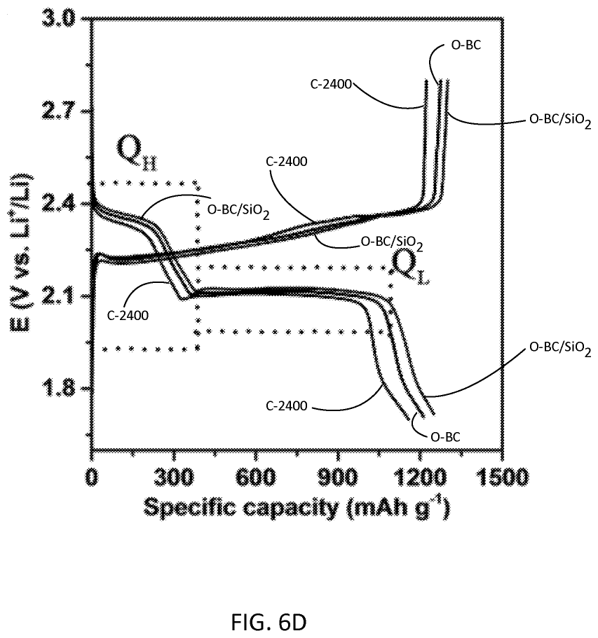

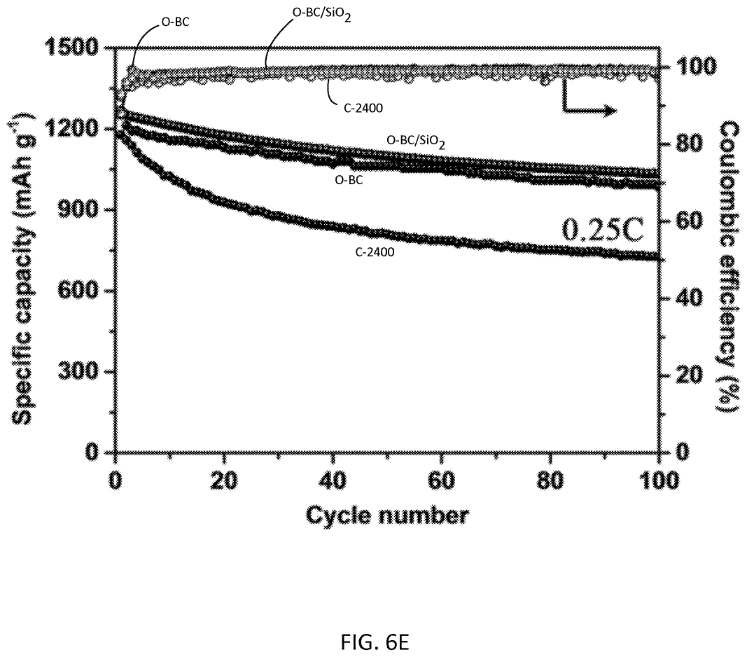

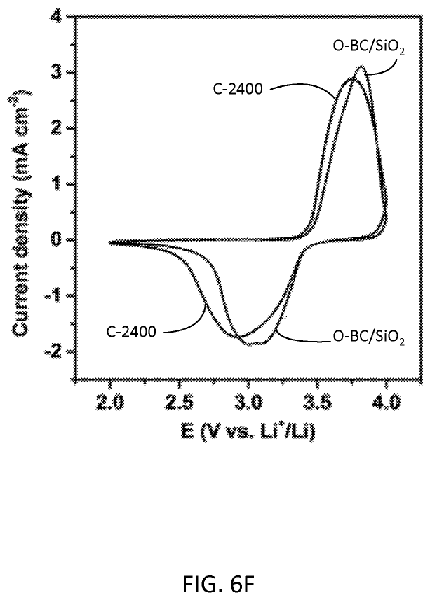

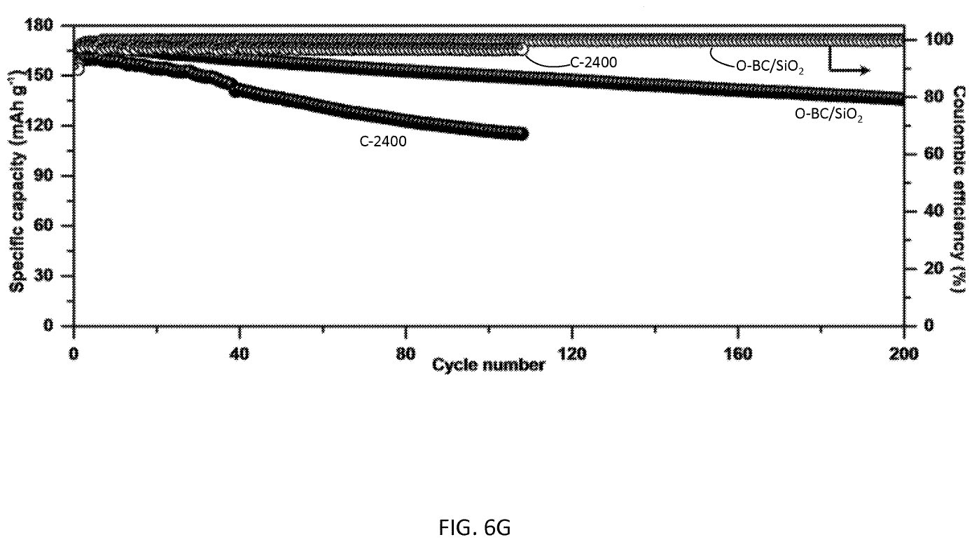

The coin-type LSB cells with the different separators were evaluated by CV and EIS techniques. As presented in FIG. 6A (CV curves recorded at 0.1 mVs⁻¹), all cells show three peaks located at ~2.30, 2.05, and 2.45 V originating from conversion of S₈ to Li₂Sx (x≥4), Li₂Sx to Li₂S/Li₂S₂, and Li₂S/Li₂S₂ to L₂Sx, respectively. The peak currents and potential differences between the redox peaks can be used to compare the related reaction kinetics. The o-BC/SiO₂ 116 based LSB has the highest peak currents and smallest peak potential differences among the three cells, indicating that the o-BC/SiO₂ 116 separator has the attractive capability to boost the redox reactions of polysulfides.

The charge transfer resistance (Rct) can be derived by fitting the Nyquist plots using the equivalent circuit presented in FIG. 6B. Again, the cell with o-BC/SiO₂ 116 separator has the lowest Rct of ~39 Ω, while it is around 55 and 44 Ω for C-2400 and o-BC 106 based cells, respectively.

If the shuttling process of polysulfides is not suppressed, self-discharging can become prevalent in the LSBs. After the first charging process, the open-circuit voltage (OCV) of cells with different separators were monitored for 12 hours and the results are summarized in FIG. 6C. The C-2400 cell experiences a relatively fast voltage drop from 2.41 to 2.35 V, while both o-BC 106 and o-BC/SiO₂ 116 based cells exhibit very stable OCV, suggesting the self-discharging, or polysulfides shuttling, has been effectively suppressed by the o-BC 106 and o-BC/SiO₂ 116 separators.

To verify that the function of BC-derived separators in improving battery performance, LSB cells with a large sulfur loading of 4 mg cm⁻² were assembled. A carbonized BC nanofiber film loaded with sulfur was used for the cathode because it offers highly conductive networks and abundant surfaces for sulfur/polysulfides to attach. These cells were cycled at 0.25 C for 100 cycles. As illustrated in FIG. 6D, the cell using an o-BC/SiO 2 116 separator delivers a larger capacity during discharge, with both higher QH that corresponds to the discharge capacity for S₈ to Li₂Sx conversion and QL that corresponds to Li₂Sx to Li₂S/Li₂S₂ conversion, than the o-BC-based and the C-2400-based cells. The trend of discharge capacity variation of the three cells is consistent with our expectation based on the CV results. As shown in FIG. 6E, during cycling the C-2400 cell shows a faster specific capacity decay than the other two and maintains a capacity of ~740 mAh g⁻¹ up to the 100th cycle. Comparatively, the cell with o-BC 106 or o-BC/SiO₂ 116 can still deliver ~1000 mAh g⁻¹ of capacity up to the 100th cycle (~985 mAh g⁻¹ for o-BC 106 cell and ~1033 mAh g⁻¹ for the o-BC/SiO₂ 116 cell). In addition, the o-BC/SiO₂ 116 cell also exhibits higher Coulombic efficiency (>99%) than its counterparts.

Li//LiFePO₄ cells with C-2400 and o-BC/SiO₂ 116 separators were also assembled and tested. FIG. 6F presents the CV curves recorded between 2.0 and 4.0 V at a scan rate of 0.1 mV s-1. The redox peak currents and peak potential differences of the o-BC/SiO₂ 116 based cell are also superior to those of the C-2400 based cell. When both cells are cycled at 0.2 C, the cell with the C-2400 separator suffers from quicker capacity decay and lower Coulombic efficiency, as shown in FIG. 6G. Although the o-BC/SiO₂ 116 cell also shows the specific capacity decrease during cycling, it only slowly decreases from the initial value of 165 to 136 mAh g⁻¹ after 200 cycles, again demonstrating the capability of the o-BC/SiO₂ 116 separator in improving the battery performance. The improved performance is attributed to the capability of SiO₂ functionalized BC to regulate the Li+flux to the anode during the Li deposition.

In some embodiment, the battery separator contemplated herein may have a thickness between 25 μm and 30 μm. In other embodiments, the contemplated separator may have a thickness in the range of 10 μm to 40 μm. Additionally, in some embodiments the contemplated separator may have a density between 10 and 50 g/m².

Where the above examples, embodiments and implementations reference examples, it should be understood by those of ordinary skill in the art that other materials and techniques could be intermixed or substituted with those provided. In places where the description above refers to particular embodiments of oxidized bacterial cellulose separators for batteries and method for producing the same, it should be readily apparent that a number of modifications may be made without departing from the spirit thereof and that these embodiments and implementations may be applied to other battery technologies as well. Accordingly, the disclosed subject matter is intended to embrace all such alterations, modifications and variations that fall within the spirit and scope of the disclosure and the knowledge of one of ordinary skill in the art.

What is claimed is:

1. A method for fabricating a separator for a lithium-based battery, comprising:
oxidizing cellulose fibrils to form oxidized cellulose having carboxylic functional groups;
decorating the oxidized cellulose with nanoparticles; and
forming the nanoparticle-decorated oxidized cellulose into a film to become the separator for the lithium-based battery,
wherein the nanoparticles are composed of a single atom catalyst based on one of Fe, V, Mo, Co, Ti, and Ge.

2. The method of claim 1, wherein the cellulose fibrils are bacterial cellulose fibrils.

3. The method of claim 1, wherein the lithium-based battery is a lithium-metal battery.

4. The method of claim 1, wherein the lithium-based battery is a lithium-sulfur battery.

5. The method of claim 1, wherein the cellulose fibrils are oxidized through a TEMPO oxidation.

6. The method of claim 1, wherein decorating the oxidized cellulose with nanoparticles comprises introducing a precursor solution to the oxidized cellulose that reacts with hydroxyl groups of the oxidized cellulose while preserving the carboxylic functional groups, causing the nanoparticles to nucleate on a surface of the oxidized cellulose.
